(19) United States
(12) Patent Application Publication
(10) Pub. No.: US 2017/0345039 A1
(43) Pub. Date: Nov. 30, 2017

(54) METHODS, SYSTEMS, NETWORKS, AND MEDIA FOR SOCIAL PAYMENTS

(71) Applicant: MASTERCARD INTERNATIONAL INCORPORATED, Purchase, NY (US)

(72) Inventors: Avyaktanand Tiwary, Gurgaon (IN); Sheetanshu D. Gupta, Jaipur (IN); Rohit Modi, Vasant Kunj (IN); Mayank Prakash, Dehradun (IN)

(21) Appl. No.: 15/166,923

(22) Filed: May 27, 2016

(51) Int. Cl. G06Q 30/02; H04L 12/58; G06Q 50/00

(52) U.S. Cl. CPC G06Q 30/0217; H04L 51/32; G06Q 30/0222; G06Q 50/01

(57) ABSTRACT

A method of determining a discount amount for an electronic commerce transaction can include determining, by a processor, whether a member of a financial institution has posted a review for an electronic commerce purchase within a preset threshold amount of time from a time when the member received a purchased item. Upon identifying the time at which the member posted the review, the processor can determine an eligible time period based on the preset threshold amount of time and the identified posting time. The processor can determine the number of occurrences of different eligible discount earning events by tracking, for the eligible time period, activities related to the review performed on one or more social media platforms. The processor can determine a discount amount based on the determined discount earning events and transmit an instruction to credit a financial account with a credit amount corresponding to the discount amount.

### BACKGROUND

The disclosed subject matter relates to methods, systems, networks, and media for determining discounts on electronic commerce transactions based on social media activity.

With the proliferation of social media, customers are more likely to pay attention to purchase products and services that their friends recommend. With advances in social media and electronic commerce (e-commerce) technology, it is becoming increasingly common for consumers to browse products online that they see their friends using on social media and for merchants to advertise their products on social media.

Currently, new products and services with no brand and/or name recognition face the problem of widespread customer awareness and marketing. Such problems are especially more aggravated for products/services that do not cater to the mass market (e.g., movies appealing to a very niche market segment, small budget movies, documentaries, etc.) or those products/services that are offered and or sold by newcomers to an industry (e.g., book from a new author or a new gadget by a startup with no name recognition). Furthermore, a lack of online reviews for such new products/services results in end consumers feeling skeptical in buying such products/services because of lack of any brand value attached to it. Currently, new merchants/individuals sell their products at heavy discounts or sometimes for free to spread the word and they spend large sums of money for promotional marketing, which is often ineffective in sales before the new merchants/individuals have depleted their funding.

Accordingly, there exists a need for improved techniques for incentivizing new product/service promotional marketing by integrating e-commerce platforms with social media platforms.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a method for determining a discount amount for an electronic commerce transaction is disclosed. The method can include determining, by a processor, whether a member of a financial institution (e.g., a credit card account holder, bank account holder, etc.) has posted a review on one or more social media platforms for an electronic commerce purchase within a preset threshold amount of time from a time when the member received a product and/or service associated with the electronic commerce purchase. The processor can identify the time at which the member has posted the review and determine an eligible time period based on the preset threshold amount of time and the identified time at which the member posted the review. The processor can track, during the eligible time period, one or more types of activities related to the review on one or more social media platforms. The processor can determine the number of occurrences of different eligible discount earning events that occurred during the eligible time period by performing the tracking. The processor can determine a discount amount to be awarded to the member based on the determined number of occurrences of the different eligible discount earning events. The processor can transmit, to the financial institution, an instruction to credit a financial account of the member with a credit amount corresponding to the discount amount.

For purpose of illustration and not limitation, the method can include receiving, by the processor, transaction information for the electronic commerce purchase conducted by the member of the financial institution, wherein the transaction information includes a price that the member has paid to purchase the product and/or service.

For purpose of illustration and not limitation, the different eligible discount earning events comprise at least one or more of a viewing, by a social media connection of the member, of a social media post comprising a link to the review, a clickthrough, by the social media connection, of the link to the review, resulting in a viewing of the review, and a purchase, by the social media connection, of the product and/or service associated with the review as a result of the social media connection viewing the review. Determining the discount can further include assigning a weight to each of the different eligible discount earning events and calculating a total discount amount by performing a weighted sum using each of the different eligible discount earning events. The weight assigned to the purchase can be greater than a weight assigned to the clickthrough and a weight assigned to the viewing, and wherein the weight assigned to the clickthrough can be greater than the weight assigned to the viewing.

For purpose of illustration and not limitation, in one implementation, the processor can determine the time when the member received the product and/or service associated with the electronic commerce purchase by receiving a shipment status from an electronic commerce platform through which the transaction was conducted. In another implementation, the processor can determine the time when the member received the product and/or service associated with the electronic commerce purchase by determining a date of delivery of the product and/or service by using an electronic tracking number received from the electronic commerce platform. In another implementation, the processor can determine the time when the member received the product and/or service associated with the electronic commerce purchase by receiving an indication from the electronic commerce platform that the product and/or service has been received by the member.

For purpose of illustration and not limitation, the processor can stop tracking the occurrence of the different eligible discount earning events after the eligible time period has expired. Occurrences of the different eligible discount earning events after the eligible time period can be excluded from being factored into the determination of the discount amount.

For purpose of illustration and not limitation, in order to credit the financial account of the member with the credit amount corresponding to the discount amount, the processor can determine financial account information of the member and can instruct at least one of the electronic commerce retailer and the financial institution to issue the credit amount corresponding to the determined discount amount to the financial institution of the member.

For purpose of illustration and not limitation, upon submission of the review by the member, the processor can generate and display, to the user, a unique link to the review to share on social media platforms. Viewing and/or clicking the link by social media users within the eligible time period can increase the discount amount to be awarded to the member.

For purpose of illustration and not limitation, processor can determine at least one social media account associated with the member of the financial institution and determine whether a social media post including a link to the review has been posted to at least one social media platform.

In accordance with another aspect of the disclosed subject matter, an apparatus for determining a discount amount for an electronic commerce transaction is disclosed. The apparatus can include at least one receiver configured to receive information from social media platforms and electronic commerce platforms and a processor that is coupled to the receiver. The processor can be configured to determine whether a member of a financial institution has posted a review on one or more social media platforms for an electronic commerce purchase within a preset threshold amount of time from a time when the member received a product and/or service associated with the electronic commerce purchase. The processor can identify the time at which the member has posted the review. The processor can determine an eligible time period based on the preset threshold amount of time and the identified time at which the member posted the review. The processor can track, during the eligible time period, one or more types of activities related to the review that was performed on the one or more social media platforms and determine the number of occurrences of different eligible discount earning events that occurred during the eligible time period by performing the tracking. The processor can determine a discount amount to be awarded to the member based on the determined number of occurrence of the different eligible discount earning events. The processor can transmit, to the financial institution, an instruction to credit a financial account of the member with a credit amount corresponding to the discount amount.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative payment network according to an illustrative embodiment of the disclosed subject matter.

FIG. 2 is a diagram illustrating a system for determining social media based discounts on e-commerce purchases according to an illustrative embodiment of the disclosed subject matter.

FIG. 3 is a flow chart illustrating a representative method, for determining social media based discounts on e-commerce purchases, implemented according to an illustrative embodiment of the disclosed subject matter.

FIG. 4 is a block diagram illustrating further details of a representative computer system according to an illustrative embodiment of the disclosed subject matter.

Throughout the drawings, the same reference numerals and characters, unless otherwise stated, are used to denote like features, elements, components or portions of the illustrated embodiments. Moreover, while the present disclosed subject matter will now be described in detail with reference to the figures, it is done so in connection with the illustrative embodiments.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The methods, systems, networks, and media presented herein can be used for determining a discount amount for an electronic commerce transaction.

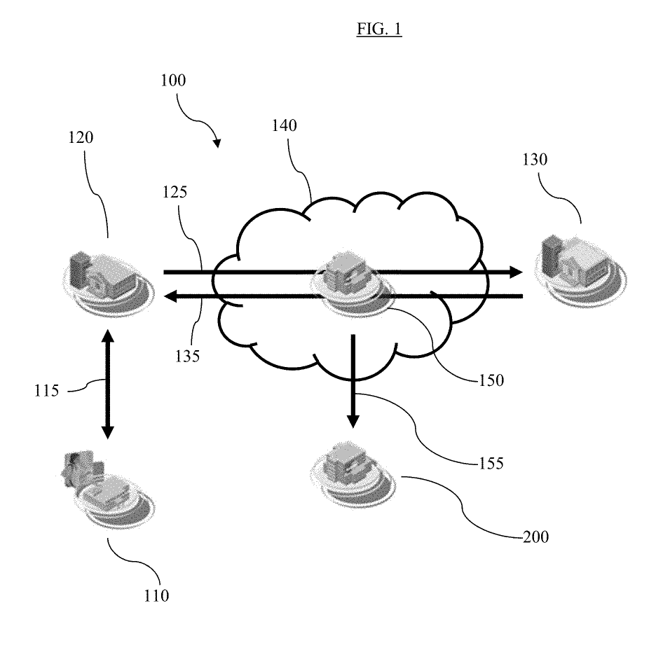

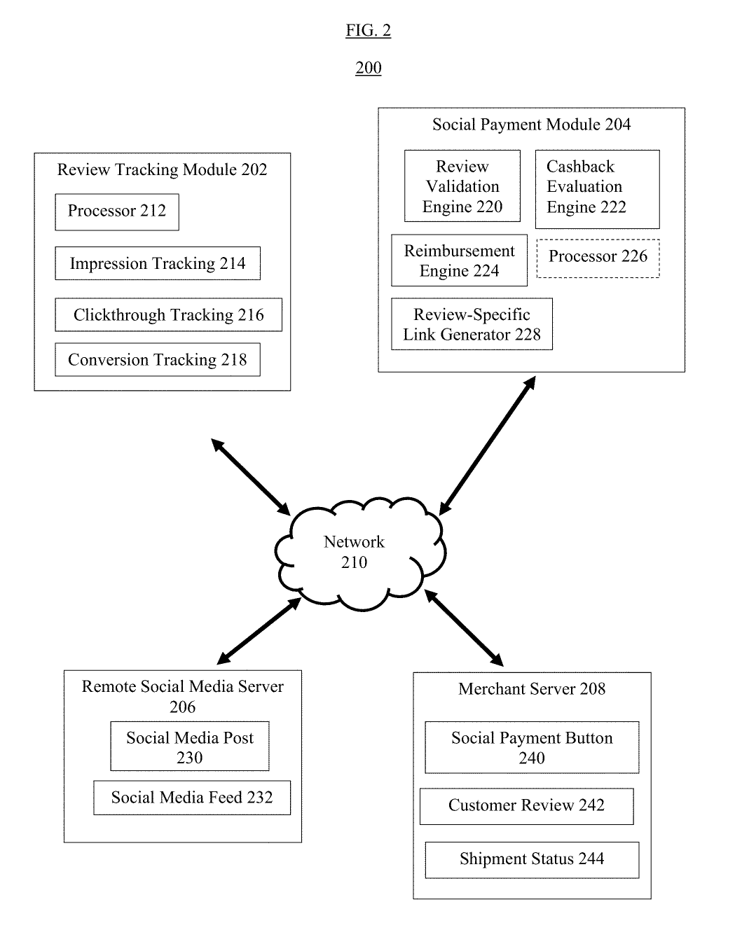

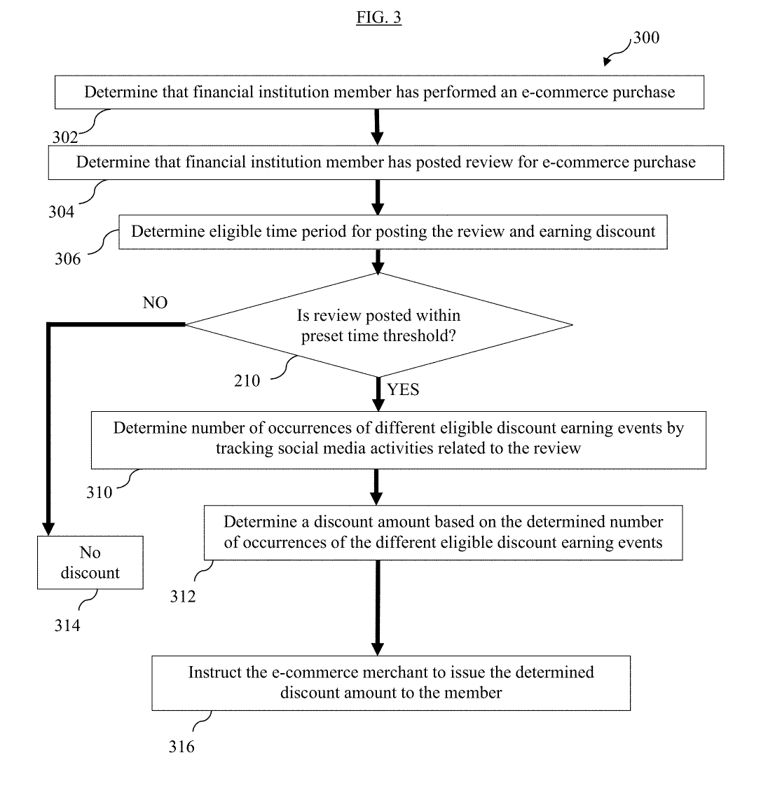

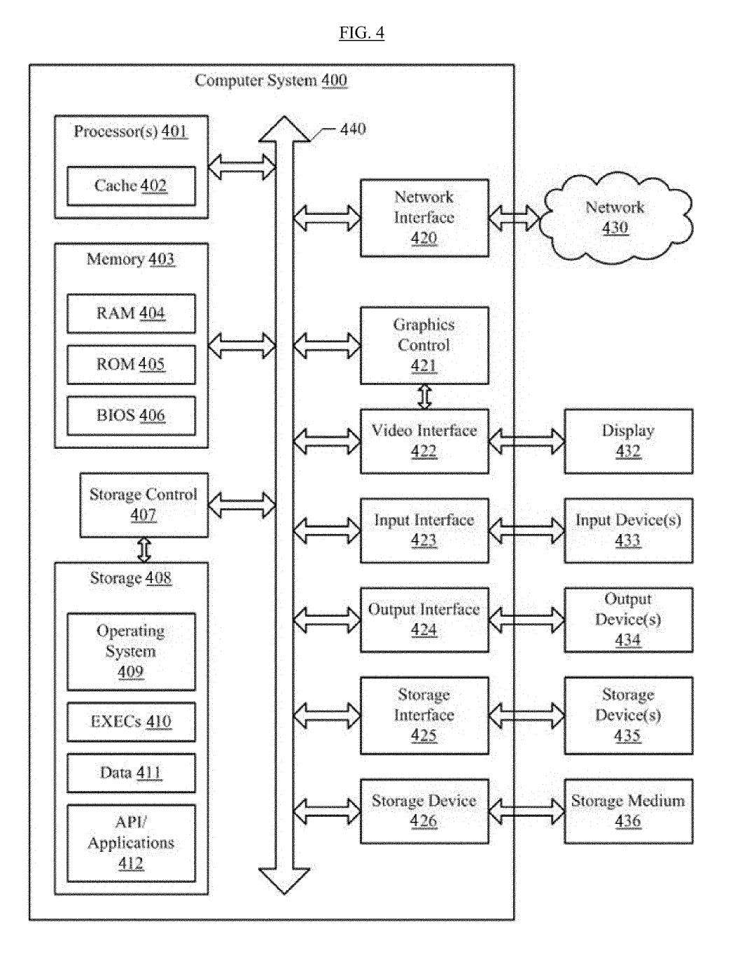

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, an exemplary embodiment of a payment network for predicting acceptance of a commercial card product in accordance with the disclosed subject matter is shown in FIG. 1. FIG. 2 shows an exemplary block diagram of a system for determining a discount amount for an electronic commerce transaction in accordance with the disclosed subject matter. FIG. 3 shows an exemplary embodiment of a method for determining a discount amount for an electronic commerce transaction in accordance with the disclosed subject matter. An exemplary embodiment of a computer system for use with the disclosed subject matter is shown in FIG. 4. While the present disclosed subject matter is described with respect to using methods, systems, networks, and media for determining a discount amount for an electronic commerce transaction, one skilled in the art will recognize that the disclosed subject matter is not limited to the illustrative embodiments. For example, the methods, systems, networks, and media for determining a discount amount for an electronic commerce transaction can be used with a wide variety of non-e-commerce transaction settings, such as in-store merchant transactions, increasing customer awareness for a non-profit/charitable cause, crowd-funding, and a variety of other applications.

FIG. 1 depicts a diagram illustrating a representative payment network 100 according to an illustrative embodiment of the disclosed subject matter. Payment network 100 can allow for payment transactions in which merchants and card issuers do not necessarily have a one-to-one relationship. The payment network 100, for example and without limitation a credit card payment system, can utilize an electronic payment network 140, such as the MasterCard® payment card system interchange network. The MasterCard® payment card system interchange network is a proprietary communications standard promulgated by MasterCard International Incorporated® based on the ISO 8583 message format for the exchange of financial transaction data between financial institutions that are customers of MasterCard International Incorporated. (MasterCard is a registered trademark of MasterCard International Incorporated located in Purchase, N.Y.)

As embodied herein, the payment network 100 for determining a discount amount for an electronic commerce transaction can include at least one merchant 110 connected to at least one electronic payment network 140, either directly or through an acquirer 120 via connection 115. At least one acquirer 120 can be connected to the electronic network 140, and each merchant 110 can be in communication with at least one acquirer 120 via the at least one payment network 140 or connection 115. At least one issuer 130 can be connected to the electronic network 140, and each acquirer 120 can be in communication with at least one issuer 130 via the electronic payment network 140.

For purpose of illustration and not limitation, in payment network 100, a financial institution, such as an issuer 130, can issue an account, such as a credit card account or a debit card account, to a cardholder (e.g., an individual consumer or a corporate or commercial customer), who can use the payment account card to tender payment for a purchase from a merchant 110 or to conduct a transaction at an ATM or website. To accept payment with the payment account card, merchant 110 can establish an account with a financial institution that is part of the financial payment system. This financial institution can be referred to as the “merchant bank” or the “acquiring bank,” or herein as “acquirer 120.” When a cardholder tenders payment for a purchase with a payment account card, the merchant, ATM, or website 110 can request authorization from acquirer 120 for the amount of the purchase. The request can be performed over the telephone, online via a website, or through the use of a point-of-sale terminal which can read the cardholder's account information from the magnetic stripe on the payment account card, from a smart card using contact pads, contactlessly from a near-field communication (NFC) device, or from manual entry and communicate electronically with the transaction processing computers of acquirer 120. Alternatively, acquirer 120 can authorize a third party to perform transaction processing on its behalf. In this case, the point-of-sale terminal can be configured to communicate with the third party. Such a third party can be referred to as a “merchant processor” or an “acquiring processor.”

As embodied herein, using payment network 140, the computers of acquirer 120 or the merchant processor can communicate information regarding payment card transactions with computers of the issuer 130. For example and not limitation, information regarding payment card transactions can include an authorization request 125 and an authorization response 135. An authorization request 125 can be communicated from the computers of the acquirer 120 to the computers of issuer 130 to determine whether the cardholder's account is in good standing and whether the purchase is covered by the cardholder's available credit line or account balance. Based on these determinations, the authorization request 125 can be declined or accepted, and an authorization response 135 can be transmitted from the issuer 130 to the acquirer 120, and then to the merchant, ATM, or website 110. The authorization request 125 can include account information identifying the merchant, location information (e.g., an address of the merchant), and transaction information, as discussed herein. The authorization response 135 can include, among other things, a result of the determination that the transaction is approved or declined and/or information about the status of the payment card or payment account.

For example and not limitation, at least one payment network server 150 can be connected to the electronic payment network 140 and configured to automatically capture the data representing a plurality of variables related to payment card transactions from the electronic payment network 140. As embodied herein, the payment network server 150 can be configured to only capture the data representing a plurality of variables related to payment card transactions with the permission of the cardholder. Additionally, the payment network server 150 can be configured to only capture the information regarding payment card transactions in accordance with applicable data privacy laws.

FIG. 2 depicts a block diagram illustrating a representative system 200 for determining a discount amount for an electronic commerce transaction according to an illustrative embodiment of the disclosed subject matter. The exemplary system 200 can include at least a review tracking module 202, a social payment module 204, a remote social media server 206, and a merchant server 208, which can all communicate with each other over network 210. Network 210 may be a wireless network, local area network, the world wide web, or any other suitable network.

As embodied herein, the review tracking module 202 can include at least a processor 212, an impression tracking module 214, a clickthrough tracking module 216, and a conversion tracking module 218. The review tracking module 202 can mine social media feeds (e.g., examine social media feed 232 on remote social media server 206) to determine the occurrence of different eligible discount earning events based on social media activity on one or more social media platforms. Social media platforms can include Facebook, Instagram, Twitter, Foursquare, LinkedIn, blog websites, personal websites, and any other similar platforms. In some embodiments, review tracking module 202 can be a part of third party computing system. In other embodiments, the review tracking module 202 can be a part of the social payment module 204 (e.g., processor 212 and processor 226 can be the same entity). The processor 212 can mine social media posts 230 and social media feeds 232 from remote social media servers 206 of various different social media platforms to identify occurrences of different eligible discount earning events. Examples of different eligible discount earning events can include impressions (e.g., when a social media connection of a user views a social media post 230 including a link to the customer review 242 posted by the user), clickthrough (e.g., when the social media connection clicks the specific custom-generated link), and conversion (e.g., when the social media connection purchases the product and/or service associated with the customer review 242 as a result of clicking the link to the customer review 242 in the social media post 230). Once a user posts a social media post 230 containing a customized link to the customer review 242, the impression tracking module 214 can monitor the number of times the social media post 242 has been viewed by his users. The social media post 230 can be a post by the user describing that he has reviewed the product and include a customized and/or trackable URL (e.g., hyperlink) to the customer review 242, which can be posted on the e-commerce retailer's website. Similarly, clickthrough tracking module 216 can determine the number of times a social media connection of the user clicks the URL and navigates to the customer review 242. For example, the URL in the social media post 230 can be trackable and specifically customized to the user who has posted the customer review 242 such that only those who navigate to the customer review 242 using such a URL who are being directed from the social media post 230 of the user. In other words, the trackable URL can be a customized shortened URL to the customer review 242 that is only available to those who have been directly referred to the customer review 242 from the social media post 230. The conversion tracking module 218 can determine which users who have clicked through the social media post 230's customized hyperlink to the customer review 242 end up purchasing the product and/or service that the review 242 is describing. For example, the conversion tracking module 218 can determine which users purchase the product and/or service on the e-commerce retailer's website of the customer review 242 within the same session as that in which they are led to the e-commerce retailer's website from the social media post 230's link to the customer review 242 describing that particular product and/or service. In some embodiments, the impression tracking module 214, clickthrough tracking module 216, and conversion tracking module 218 can determine occurrences of impressions, clickthroughs, and conversions, respectively, during an eligible time window (e.g., a window of time between when the user posts the customer review 242 and a preset amount of days between when the user has received the product and/or service). After the eligible time window expires, the impression tracking module 214, clickthrough tracking module 216, and conversion tracking module 218 can stop tracking occurrences of impressions, clickthroughs, and conversions, respectively. The eligible time window can be set by the social payment module 204.

As embodied herein, the social payment module 204 can include at least a review validation engine 220, a cashback evaluation engine 222, a reimbursement engine 224, a processor 226, and a review-specific link generator 228. The social payment module 204 can track user purchases on an e-commerce platform (e.g., website, mobile application, in-store purchase at an e-commerce vendor location), monitor the social media activity of reviews created by the user of products/services purchased on the e-commerce platform, and accordingly calculate how much of a discount to disburse to the user based on the social media activity generated by his/her review. Although the disclosure refers to the various components of the social payment module 204 (e.g., the review validation engine 220, cashback evaluation engine 222, reimbursement engine 224, and review-specific link generator 228) performing different actions, it is to be understood that the processor 2226 directs and/or performs such actions in conjunction with these various components.

In some embodiments, a user (e.g., a member of a financial institution such as a holder of a MasterCard®-branded credit card issued by a bank) engages in an e-commerce transaction with an e-commerce merchant through an e-commerce platform, the user can have the option of purchasing the product and/or service through conventional means (e.g., pressing a buy button on the e-commerce website) or purchasing the product and/or service using social payment means described in this disclosure (e.g., by pressing a social payment button 240 on the e-commerce website). Once the user presses a social payment button 240 on the vendor's e-commerce website, the full price of the product and/or service is initially charged to the user's payment means and the user's social media activity is monitored for a preset amount of time (e.g., an eligible time window) to determine how much discount to credit the user with based on the amount of promotion and/or marketing generating on social media through his subsequently posted customer review 242 for the product and/or service that he purchased through social payment. Upon determining that an e-commerce consumer has transacted with the e-commerce merchant by selecting the social media button 240, the social payment module 204 can identify at least one or more social media accounts of that e-commerce consumer (e.g., prompting the user to enter his social media account information, identifying the social media account information from active login sessions in the same browser session as the e-commerce transaction, receiving social media account information from the user's e-commerce account, receiving the user's social media account information from social media server 206, etc.). Once the social payment module 204 has identified the social media accounts of the e-commerce consumer, the social payment module 204 can determine whether the e-commerce consumer has posted a customer review 242 for the product and/or service that he has purchased on the e-commerce platform using the social payment button 240. For example, the social payment module 204 can monitor social media activity on the at least one or more social media accounts to determine whether a social media post 230 including a customized URL to the customer review 242 has been posted within the eligible time window.

In some embodiments, the social payment module 204 can check reviews generated by users participating in the social payment scheme to ensure that the reviews pass preset standards. The review validation engine 220 can identify new customer reviews that a user has generated for e-commerce products that he/she has purchased and check the identified customer reviews using previously established fraud prevention and/or compliance rules. For example, the review validation engine 220 can check the review to determine whether the review mentions the product and/or service purchased by the user, whether the review exceeds a preset minimum amount of characters, whether the review contains vulgar and/or inappropriate language, whether the review contains promotions for other products/events/services indicative of spam, whether the review includes excessive grammar and/or spelling errors, etc. The review validation engine 220 can flag and/or delete reviews that do not satisfy the previously established rules. In some embodiments, the review validation engine 220 can provide the flagged reviews to the e-commerce platform administrator who can make the decision on whether the reviews are to be left alone or expunged.

In some embodiments, the social payment module 204 can determine the amount of discount to award to a user who has written a review for an e-commerce transaction. For example, the cashback evaluation engine 222 can evaluate the discount amount based on the eligible time window between when a user posts customer review 242 and a preset number of days from when the user has received the product and/or service described in the customer 242. The cashback evaluation engine 222 can determine when the user has received the product and/or service purchased on the e-commerce retailer's platform by receiving a shipment status 244 from an e-commerce retailer and/or the merchant server 208 through which the transaction was conducted, determining a date of delivery of the product and/or service by using electronic tracking number received from the e-commerce retailer, and/or receiving an indication from the electronic commerce retailer that the product and/or service has been received by the user. Once the cashback evaluation engine 222 identifies when the product and/or service was received by the user, the cashback evaluation engine 222 can set that time to be the start of eligible time window. In an exemplary implementation, an eligible time window can be valid for 7 days from the date of receipt of the product and/or service of e-commerce purchase. The cashback evaluation engine 222 can determine at which period of this eligible window the user posts the customer review 242 and tally the number of different eligible discount earning events between the time the user posts customer review 242 and the end of the eligible time window. For example, if the user posts the customer posts the customer review 242 on the same day as the product and/or service is received, the cashback evaluation engine 222 can tally the number of eligible discount earning events for 7 days until the eligible time window expires. However, if the user posts the customer posts the customer review 242 six days from the day on which the product and/or service is received, the cashback evaluation engine 222 can tally the number of eligible discount earning events for one day until the eligible time window expires. In this manner, the cashback evaluation engine 222 awards the most discount to those users who post reviews about their purchases the earliest on social media.

In some embodiments, the social payment module 204 can score different eligible discount earning events differently in the calculation of the discount amount to award the user. For example, the cashback evaluation engine 222 can assign a different weight to each of the different types of eligible discount earning events and calculate a total discount amount to be awarded to the user based on the weighted sum of all the eligible discount earning events that occur within the eligible time window. In an exemplary implementation, a weight assigned to a conversion event can be greater than the weight assigned to a clickthrough event and a weight assigned to the impression event. The weight assigned to the clickthrough event can be greater than the weight assigned to the impression event.

In some embodiments, the social payment module 204 can process reimbursements to users in the amount of the calculated discount based on the social media activity on their reviews. For example, the reimbursement engine 224 can instruct the e-commerce merchant to issue the calculated discount amount to the financial institution member for each purchase based on the social media activity (e.g., impressions, clickthrough, and conversions) generated by the member's customer review 242 associated with a corresponding purchase on the e-commerce platform. The reimbursement engine 224 can provide the e-commerce merchant with the financial institution member's payment method of choice (e.g., credit card account information, bank account information, digital wallet account information, etc.) to be credited with the discount amount. In another implementation, the reimbursement engine 224 can instruct the e-commerce merchant to issue the financial institution member store credit in the amount of the calculated discount amount that can be used on his future purchase(s) from the merchant's e-commerce platform. In another implementation, the reimbursement engine 224 can instruct the e-commerce merchant and/or the e-commerce merchant's bank to issue the financial institution member with loyalty reward credit in the amount equivalent to the calculated discount amount.

In some embodiments, the social payment module 204 can generate customized hyperlinks to the customer review 242. For example, once the user posts a customer review 242 on the e-commerce platform, the review-specific link generator 228 can generate a customized and/or trackable URL (e.g., hyperlink) to the customer review 242 posted on the e-commerce platform's website. The review-specific link generator 228 can display the customized URL to the user to share on social media platforms. The URL can be trackable and specifically customized to the user who has posted the customer review 242 such that those who navigate to the customer review 242 using such a URL are only those who are being directed from the social media post 230 of the user including the customized URL. In other words, the trackable URL can be a customized shortened URL to the customer review 242 that is only available to those who have been directly referred to the customer review 242 from the social media post 230.

In some embodiments, the social payment module 204, working in tandem with review tracking module 202, can determine the total number of occurrences of different eligible discount earning events from a plurality of sources in which the link to the customer review 242 is shared. For example, if the member shares the hyperlink to the customer review 242 on multiple different social media platforms (e.g., multiple different social media posts 230), the social payment module 204 can track the aggregate number of occurrences of different eligible discount earning events based on social media activity associated with each of those posts. In another embodiment, if a social media connection of the member shares and/or reports the original member's social media post 230 including the customized hyperlink to the customer review 242, the social payment module 204 can track the aggregate number of occurrences of different eligible discount earning events based on social media activity generated from all such reposts and/or shares of the original member's social media posts.

FIG. 3 is a flow chart illustrating a representative method 300 implemented according to an illustrative embodiment of the disclosed subject matter. The exemplary network 100 of FIG. 1 and system 200 of FIG. 2, for purpose of illustration and not limitation, are discussed with reference to the exemplary method of FIG. 3.

As embodied herein, at 302, the processor can determine that a member of a financial institution has performed an e-commerce purchase. For example, processor 226 can determine whether an e-commerce consumer (e.g., a financial institution member associated with a social media account) has purchased a product and/or service through the e-commerce platform using the social payment button 240. The processor 226 can receive transaction information for the purchase, including a price that the e-commerce consumer has paid to the e-commerce merchant at the time of the purchase of the product and/or service.

At 304, the processor can determine that the financial institution member has posted a review for the e-commerce purchase. For example, processor 226 can determine whether the user who purchased the product and/or service using the social payment button 240 has posted a customer review 242 on the e-commerce platform for the product and/or service that he has purchased. The processor 226, in tandem with review validation engine 220, can determine whether the financial institution member has generated a valid review that meets pre-established rules for an eligible customer review.

At 306, the processor can determine the eligible time period for posting the review and earning a discount. For example, the processor can determine a preset threshold amount of time from a time when the member received a product and/or service associated with the electronic commerce purchase (e.g., 7 days from date of the member receiving the product and/or service). The processor can determine the time when the member received the product and/or service associated with the electronic commerce purchase by receiving a shipment status 244 from an electronic commerce retailer through which the transaction was conducted, determining a date of delivery of the product and/or service by using electronic tracking number received from the electronic commerce retailer, and/or receiving an indication from the electronic commerce retailer that the product and/or service has been received by the member. The processor 226 can determine an eligible time period based on the preset threshold amount of time by identifying the time at which the member posted the review 242. For example, if the member posted the review two days after receiving the product and/or service and the preset threshold of time for generating discount cashback is seven days from time of receipt of the product and/or service, the processor 226 can identify these criteria and/or parameters and calculate that the eligible time period for posting the review and earning a discount through social media activity is five days.

At 308, the processor can determine whether the review is posted within the predetermined threshold amount of time. For example, the processor 226 can determine whether the customer review 242 was posted on the e-commerce platform and/or the social media platform within a preset threshold amount of time from the date that the member received the product and/or service. By tracking customer reviews associated with the member's e-commerce account and/or the member's social media accounts, the processor 226 can determine whether such a customer review 242 was posted within a preset threshold amount of time.

At 314, in response to determining that the review was not posted within the preset time threshold, the processor can determine that no discount is to be awarded to the member for the purchase. For example, the processor 226 can stop tracking the occurrence of the different eligible discount earning events after the eligible time period has expired. Additionally or alternatively, the processor can ignore occurrences of the different eligible discount earning events after the eligible time period and not factor them into the determination of the discount amount. The processor 226 can determine that no discount is to be awarded to the member in such an instance.

At 310, in response to determining that the review was posted within the preset time threshold, the processor can determine the number of occurrences of different eligible discount earning events by tracking the social media activities related to the review. For example, the processor 226 can determine the number of times that an impression, a clickthrough, and a conversion has occurred from the social media post 230 including the link to the customer review 242.

At 312, the processor can determine a discount amount based on the determined number of occurrences of the different eligible discount earning events. For example, the processor 226 can determine the weighting associated with each of these different eligible discount earning events and assign a total score using the weighted sum of the total number of such events within the eligible time period.

At 316, the processor can instruct the e-commerce merchant to issue the determined discount amount to the member. For example, the reimbursement engine 224 can instruct the e-commerce merchant to issue the calculated discount amount to the financial institution member for each purchase based on the social media activity (e.g., impressions, clickthrough, and conversions) generated by the member's customer review 242 associated with a corresponding purchase on the e-commerce platform. The reimbursement engine 224 can provide the e-commerce merchant with the financial institution member's payment method of choice to be credited with the discount amount. In another implementation, the reimbursement engine 224 can instruct the e-commerce merchant to issue the financial institution member with store credit in the amount of the calculated discount amount that can be used on his future purchases from the merchant's e-commerce platform. In another implementation, the reimbursement engine 224 can instruct the e-commerce merchant and/or the e-commerce merchant's bank to issue the financial institution member with loyalty reward credit in the amount equivalent to the calculated discount amount.

FIG. 4 is a block diagram illustrating further details of a representative computer system according to an illustrative embodiment of the disclosed subject matter.

The systems and techniques discussed herein can be implemented in a computer system. As an example and not by limitation, as shown in FIG. 4, the computer system having architecture 400 can provide functionality as a result of processor(s) 401 executing software embodied in one or more tangible, non-transitory computer-readable media, such as memory 403. The software implementing various embodiments of the present disclosure can be stored in memory 403 and executed by processor(s) 401. A computer-readable medium can include one or more memory devices, according to particular needs. Memory 403 can read the software from one or more other computer-readable media, such as mass storage device(s) 435 or from one or more other sources via communication interface 420. The software can cause processor(s) 401 to execute particular processes or particular parts of particular processes described herein, including defining data structures stored in memory 403 and modifying such data structures according to the processes defined by the software. An exemplary input device 433 can be, for example, a keyboard, a pointing device (e.g. a mouse), a touchscreen display, a microphone and voice control interface, or the like to capture user input coupled to the input interface 423 to provide data and/or user input to the processor 401. An exemplary output device 434 can be, for example, a display (e.g. a monitor) or speakers coupled to the output interface 424 to allow the processor 401 to present a user interface, visual content, and/or audio content. Additionally or alternatively, the computer system 400 can provide an indication to the user by sending text or graphical data to a display 432 coupled to a video interface 422. Furthermore, any of the above components can provide data to or receive data from the processor 401 via a computer network 430 coupled the communication interface 420 of the computer system 400. In addition or as an alternative, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

In some embodiments, processor 401 includes hardware for executing instructions, such as those making up a computer program. As an example and not by way of limitation, to execute instructions, processor 401 can retrieve (or fetch) the instructions from an internal register, an internal cache 402, memory 403, or storage 408; decode and execute them; and then write one or more results to an internal register, an internal cache 402, memory 403, or storage 408. In particular embodiments, processor 401 can include one or more internal caches 402 for data, instructions, or addresses. This disclosure contemplates processor 401 including any suitable number of any suitable internal caches, where appropriate. As an example and not by way of limitation, processor 401 can include one or more instruction caches 402, one or more data caches 402, and one or more translation lookaside buffers (TLBs). Instructions in the instruction caches 402 can be copies of instructions in memory 403 or storage 408, and the instruction caches 402 can speed up retrieval of those instructions by processor 401. Data in the data caches 402 can be copies of data in memory 403 or storage 408 for instructions executing at processor 401 to operate on; the results of previous instructions executed at processor 401 for access by subsequent instructions executing at processor 401 or for writing to memory 403 or storage 408; or other suitable data. The data caches 402 can speed up read or write operations by processor 401. The TLBs can speed up virtual-address translation for processor 401. In some embodiments, processor 401 can include one or more internal registers for data, instructions, or addresses. This disclosure contemplates processor 401 including any suitable number of any suitable internal registers, where appropriate. Where appropriate, processor 401 can include one or more arithmetic logic units (ALUs); be a multi-core processor; or include one or more processors 401. Although this disclosure describes and illustrates a particular processor, this disclosure contemplates any suitable processor.

In some embodiments, memory 403 includes main memory for storing instructions for processor 401 to execute or data for processor 401 to operate on. As an example and not by way of limitation, computer system 400 can load instructions from storage 408 or another source (such as, for example, another computer system 400) to memory 403. Processor 401 can then load the instructions from memory 403 to an internal register or internal cache 402. To execute the instructions, processor 401 can retrieve the instructions from the internal register or internal cache 402 and decode them. During or after execution of the instructions, processor 401 can write one or more results (which can be intermediate or final results) to the internal register or internal cache 402. Processor 401 can then write one or more of those results to memory 403. In some embodiments, processor 401 executes only instructions in one or more internal registers or internal caches 402 or in memory 403 (as opposed to storage 408 or elsewhere) and operates only on data in one or more internal registers or internal caches or in memory 403 (as opposed to storage 408 or elsewhere). One or more memory buses (which can each include an address bus and a data bus) can couple processor 401 to memory 403. Bus 440 can include one or more memory buses, as described below. In particular embodiments, one or more memory management units (MMUs) reside between processor 401 and memory 403 and facilitate accesses to memory 403 requested by processor 401. In some embodiments, memory 403 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 403 can include one or more memories 404, where appropriate. Although this disclosure describes and illustrates particular memory, this disclosure contemplates any suitable memory.

In some embodiments, storage 408 includes mass storage for data or instructions. As an example and not by way of limitation, storage 408 can include a hard disk drive (HDD), a floppy disk drive, flash memory, an optical disc, a magneto-optical disc, magnetic tape, or a Universal Serial Bus (USB) drive or a combination of two or more of these. Storage 408 can include removable or non-removable (or fixed) media, where appropriate. Storage 408 can be internal or external to computer system 400, where appropriate. In some embodiments, storage 408 is non-volatile, solid-state memory. In some embodiments, storage 408 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 408 taking any suitable physical form. Storage 408 can include one or more storage control units facilitating communication between processor 401 and storage 408, where appropriate. Where appropriate, storage 408 can include one or more storages 408. Although this disclosure describes and illustrates particular storage, this disclosure contemplates any suitable storage.

In some embodiments, input interface 423 and output interface 424 can include hardware, software, or both, providing one or more interfaces for communication between computer system 400 and one or more input device(s) 433 and/or output device(s) 434. Computer system 400 can include one or more of these input device(s) 433 and/or output device(s) 434, where appropriate. One or more of these input device(s) 433 and/or output device(s) 434 can enable communication between a person and computer system 400. As an example and not by way of limitation, an input device 433 and/or output device 434 can include a keyboard, keypad, microphone, monitor, mouse, printer, scanner, speaker, still camera, stylus, tablet, touch screen, trackball, video camera, another suitable input device 433 and/or output device 434 or a combination of two or more of these. An input device 433 and/or output device 434 can include one or more sensors. This disclosure contemplates any suitable input device(s) 433 and/or output device(s) 434 and any suitable input interface 423 and output interface 424 for them. Where appropriate, input interface 423 and output interface 424 can include one or more device or software drivers enabling processor 401 to drive one or more of these input device(s) 433 and/or output device(s) 434. Input interface 423 and output interface 424 can include one or more input interfaces 423 or output interfaces 424, where appropriate. Although this disclosure describes and illustrates a particular input interface 423 and output interface 424, this disclosure contemplates any suitable input interface 423 and output interface 424.

As embodied herein, communication interface 420 can include hardware, software, or both providing one or more interfaces for communication (such as, for example, packet-based communication) between computer system 400 and one or more other computer systems 400 or one or more networks. As an example and not by way of limitation, communication interface 420 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 420 for it. As an example and not by way of limitation, computer system 400 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 400 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 can include any suitable communication interface 420 for any of these networks, where appropriate. Communication interface 420 can include one or more communication interfaces 420, where appropriate. Although this disclosure describes and illustrates a particular communication interface, this disclosure contemplates any suitable communication interface.

In some embodiments, bus 440 includes hardware, software, or both coupling components of computer system 400 to each other. As an example and not by way of limitation, bus 440 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 440 can include one or more buses 404, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope.

1. A method of determining a discount amount for an electronic commerce transaction, comprising:
determining, by a processor, whether a member of a financial institution has posted a review on one or more social media platforms for an electronic commerce purchase within a preset threshold amount of time from a time when the member received a product and/or service associated with the electronic commerce purchase;
identifying, by the processor, the time at which the member has posted the review;
determining, by the processor, an eligible time period based on the preset threshold amount of time and the identified time at which the member posted the review;
tracking, by the processor during the eligible time period, one or more types of activities performed on the one or more social media platforms related to the review;
determining, by the processor, the number of occurrences of different eligible discount earning events that occurred during the eligible time period by performing the tracking;
determining, by the processor, a discount amount to be awarded to the member based on the determined number of occurrences of the different eligible discount earning events; and
transmitting, by the processor and to the financial institution, an instruction to credit a financial account of the member with a credit amount corresponding to the discount amount.

2. The method of claim 1, further comprising:
receiving, by the processor, transaction information for the electronic commerce purchase conducted by the member of the financial institution, wherein the transaction information includes a price that the member has paid to purchase the product and/or service.

3. The method of claim 1, wherein the different eligible discount earning events comprise at least one or more of:
a viewing, by a social media connection of the member, of a social media post comprising a link to the review;
a clickthrough, by the social media connection, of the link to the review, resulting in a viewing of the review; and
a purchase, by the social media connection, of the product and/or service associated with the review as a result of the social media connection viewing the review.

4. The method of claim 1, further comprising:
determining, by the processor, the time when the member received the product and/or service associated with the electronic commerce purchase by at least one of:
receiving, by the processor, a shipment status from an electronic commerce platform through which the transaction was conducted;
determining, by the processor, a date of delivery of the product and/or service by using an electronic tracking number received from the electronic commerce platform;
receiving, by the processor, an indication from the electronic commerce platform that the product and/or service has been received by the member.

5. The method of claim 3, wherein determining the discount further comprises:
assigning a weight to each of the different eligible discount earning events; and
calculating a total discount amount by performing a weighted sum using each of the different eligible discount earning events.

6. The method of claim 5, wherein a weight assigned to the purchase is greater than a weight assigned to the clickthrough and a weight assigned to the viewing, and wherein the weight assigned to the clickthrough is greater than the weight assigned to the viewing.

7. The method of claim 1, wherein the processor stops tracking the occurrence of the different eligible discount earning events after the eligible time period has expired, and wherein occurrences of the different eligible discount earning events after the eligible time period are not factored into the determination of the discount amount.

8. The method of claim 1, wherein transmitting the instruction to credit the financial account of the member with a credit amount corresponding to the discount amount further comprises:
determining, by the processor, financial account information of the member; and
instructing, by the processor, at least one of an electronic commerce retailer and the financial institution to issue the credit amount corresponding to the determined discount amount to the financial account of the member.

9. The method of claim 1, wherein
upon submission of the review by the member, a unique link to the review is generated and displayed to the user to share on social media platforms, wherein viewing and/or clicking the link by social media users within the eligible time period increases the discount amount to be awarded to the member.

10. The method of claim 1, wherein determining that the member of a financial institution has posted a review further comprises:
identifying, by the processor, at least one social media account associated with the member of the financial institution; and
determining, by the processor, whether a social media post including a link to the review has been posted to at least one social media platform.

11. An apparatus for determining a discount amount for an electronic commerce transaction, comprising:
a receiver configured to receive information from social media platforms and electronic commerce platforms;
a processor, coupled to the receiver, and configured to:
determine whether a member of a financial institution has posted a review on one or more social media platforms for an electronic commerce purchase within a preset threshold amount of time from a time when the member received a product and/or service associated with the electronic commerce purchase;
identify the time at which the member has posted the review;
determine an eligible time period based on the preset threshold amount of time and the identified time at which the member posted the review;
track, during the eligible time period, one or more types of activities performed on the one or more social media platforms related to the review;
determine the number of occurrences of different eligible discount earning events that occurred during the eligible time period by performing the tracking;
determine a discount amount to be awarded to the member based on the determined number of occurrence of the different eligible discount earning events; and
transmitting, to the financial institution, an instruction to credit a financial account of the member with a credit amount corresponding to the discount amount.

12. The apparatus of claim 11, wherein the processor is further configured to:
receive transaction information for the electronic commerce purchase conducted by the member of the financial institution, wherein the transaction information includes a price that the member has paid to purchase the product and/or service.

13. The apparatus of claim 11, wherein the different eligible discount earning events comprise at least one or more of:
a viewing, by a social media connection of the member, of a social media post comprising a link to the review;
a clickthrough, by the social media connection, of the link to the review, resulting in a viewing of the review; and
a purchase, by the social media connection, of the product and/or service associated with the review as a result of the social media connection viewing the review.

14. The apparatus of claim 11, wherein the processor is further configured to:
determine the time when the member received the product and/or service associated with the electronic commerce purchase by at least one of:
receiving a shipment status from an electronic commerce platform through which the transaction was conducted;
determining a date of delivery of the product and/or service by using an electronic tracking number received from the electronic commerce platform;
receiving an indication from the electronic commerce platform that the product and/or service has been received by the member.

15. The apparatus of claim 13, wherein the processor is configured to determine the discount by:
assigning a weight to each of the different eligible discount earning events; and
calculating a total discount amount by performing a weighted sum using each of the different eligible discount earning events.

16. The apparatus of claim 15, wherein a weight assigned to the purchase is greater than a weight assigned to the clickthrough and a weight assigned to the viewing, and wherein the weight assigned to the clickthrough is greater than the weight assigned to the viewing.

17. The apparatus of claim 11, wherein the processor is further configured to stop tracking the occurrence of the different eligible discount earning events after the eligible time period has expired, and wherein occurrences of the different eligible discount earning events after the eligible time period are not factored into the determination of the discount amount.

18. The apparatus of claim 11 of claim 1, wherein the processor is further configured to:
determine financial account information of the member; and
instruct at least one of an electronic commerce retailer and the financial institution to issue the credit amount corresponding to the determined discount amount to the financial account of the member.

19. The apparatus of claim 11, wherein
upon submission of the review by the member, a unique link to the review is generated and displayed to the member to share on social media platforms, wherein viewing and/or clicking the link by social media users within the eligible time period increases the discount amount to be awarded to the member.

20. The apparatus of claim 11, wherein the processor is configured to determine that the member of a financial institution has posted a review by:
identifying at least one social media account associated with the member of the financial institution; and
determining whether a social media post including a link to the review has been posted to at least one social media platform.
